(19) United States
(12) Patent Application Publication
(10) Pub. No.: US 2019/0347541 A1
(43) Pub. Date: Nov. 14, 2019

(54) APPARATUS, METHOD AND COMPUTER PROGRAM PRODUCT FOR DEEP LEARNING

(71) Applicant: NOKIA TECHNOLOGIES OY, Espoo (FI)

(72) Inventor: Hongyang LI, Tianjin (CN)

(21) Appl. No.: 16/474,900

(22) PCT Filed: Dec. 30, 2016
(86) PCT No.: PCT/CN2016/113651

§ 371 Date: Jun. 28, 2019

(51) Int. Cl. G06N 3/04; G06N 3/08; G05D 1/02

(52) U.S. Cl. CPC G06N 3/0481; G05D 2201/0213; G05D 1/0221; G06N 3/08

(57) ABSTRACT

Apparatus (10), method, computer program product and computer readable medium are disclosed for deep learning. The apparatus (10) comprises at least one processor (11); at least one memory (12) including computer program code, the memory (12) and the computer program code configured to, working with the at least one processor (11), cause the apparatus (10) to use a two-dimensional activation function in a deep learning architecture, wherein the two-dimensional activation function comprises a first parameter representing an element to be activated and a second parameter representing the element's neighbors.

### FIELD OF THE INVENTION

Embodiments of the disclosure generally relate to information technologies, and, more particularly, to deep learning.

### BACKGROUND

Deep learning has been widely used in various fields such as computer vision, automatic speech recognition, natural language processing, drug discovery and toxicology, customer relationship management, recommendation systems, audio recognition and biomedical Informatics. However, the accuracy of the state-of-the-art deep learning methods is required to be improved. Therefore, it is required an improved solution for deep learning.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to one aspect of the disclosure, it is provided an apparatus. The apparatus may comprise at least one processor; and at least one memory including computer program code, the memory and the computer program code configured to, working with the at least one processor, cause the apparatus to use a two-dimensional activation function in a deep learning architecture, wherein the two-dimensional activation function comprises a first parameter representing an element to be activated and a second parameter representing the element's neighbors.

According to another aspect of the present disclosure, it is provided a method. The method may comprise using a two-dimensional activation function in a deep learning architecture, wherein the two-dimensional activation function comprises a first parameter representing an element to be activated and a second parameter representing the element's neighbors.

According to still another aspect of the present disclosure, it is provided a computer program product embodied on a distribution medium readable by a computer and comprising program instructions which, when loaded into a computer, causes a processor to use a two-dimensional activation function in a deep learning architecture, wherein the two-dimensional activation function comprises a first parameter representing an element to be activated and a second parameter representing the element's neighbors.

According to still another aspect of the present disclosure, it is provided a non-transitory computer readable medium having encoded thereon statements and instructions to cause a processor to use a two-dimensional activation function in a deep learning architecture, wherein the two-dimensional activation function comprises a first parameter representing an element to be activated and a second parameter representing the element's neighbors.

According to still another aspect of the present disclosure, it is provided an apparatus comprising means configured to use a two-dimensional activation function in a deep learning architecture, wherein the two-dimensional activation function comprises a first parameter representing an element to be activated and a second parameter representing the element's neighbors.

These and other objects, features and advantages of the disclosure will become apparent from the following detailed description of illustrative embodiments thereof, which is to be read in connection with the accompanying drawings.

### BRIEF DESCRIPTION OF THE DRAWINGS

FIG. 1 is a simplified block diagram showing an apparatus according to an embodiment;

FIG. 2 is a flow chart depicting a process of a training stage of deep learning according to embodiments of the present disclosure;

FIG. 3 is a flow chart depicting a process of a testing stage of deep learning according to embodiments of the present disclosure; and

FIG. 4 schematically shows a single neuron in a neural network.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement. Various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

It is noted that though the embodiments are mainly described in the context of convolutional neural network, they are not limited to this but can be applied to any suitable deep learning architecture. Moreover, the embodiments can be applied to automatic speech recognition, natural language processing, drug discovery and toxicology, customer relationship management, recommendation systems, audio recognition and biomedical Informatics, etc., though they are mainly discussed in the context of image recognition.

Generally speaking, in deep learning, an input vector is transformed to a scalar by computing the inner product of the input vector and a weight vector. In deep convolutional neural network (CNN), the weight vector is also called as a convolutional filter (or convolutional kernel) and the scalar is the result of the convolution with the filter and the input. So in the context of deep CNN, the scalar is also called as convolutional result. Then the scalar may be mapped by an activation function which is a nonlinear function.

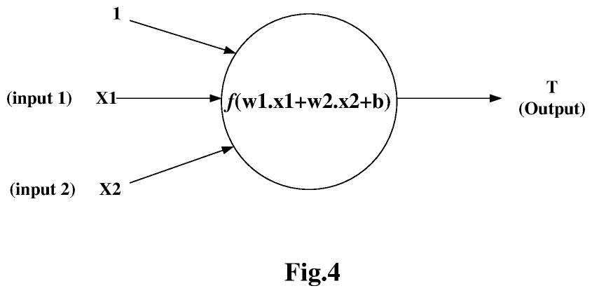

A neural network is a computational model that is inspired by the way biological neural networks in the human brain process information. The basic unit of computation in the neural network is a neuron, often called a node or unit. FIG. 4 schematically shows a single neuron in the neural network. The single neuron may receive input from some other nodes or from an external source and computes an output. Each input has an associated weight (w), which may be assigned on the basis of its relative importance to other inputs. The node applies a function ƒ( ) to the weighted sum of its inputs as shown below:

T=ƒ(w1·x1+w2·x2+b) (1)

The network as shown in FIG. 4 may take numerical inputs X1 and X2 and has weights w1 and w2 associated with those inputs. Additionally, there is another input 1 with weight b (called the Bias) associated with it. The main function of Bias is to provide every node with a trainable constant value (in addition to the normal inputs that the node receives). It is noted that there may be more than two inputs in other embodiments though only two inputs are shown in FIG. 4.

The output T from the neuron is computed as shown in equation 1. The function ƒ is non-linear and is called the activation function. The purpose of the activation function is to introduce non-linearity into the output of the neuron. This is important because most real world data is non linear and the neurons is required to learn these non linear representations.

The activation function (or non-linearity) takes a single number and performs a certain fixed mathematical operation on it. For example, The following is several existing activation functions:
Sigmoid: takes a real-valued input and squashes it to range between 0 and 1

$$sigmoid ( x ) = \frac{1}{1 + {e}^{- x}} \qquad ( 2 )$$

tanh: takes a real-valued input and squashes it to the range [−1, 1]

$$tanh ( x ) = 2 σ ( 2 x ) - 1 \qquad ( 3 )$$

ReLU: ReLU stands for Rectified Linear Unit. It takes a real-valued input and thresholds it at zero (replaces negative values with zero). Variants of ReLU have been proposed. State-of-the-art variants of ReLU include PReLU, RReLU, Maxout, ELU, CReLU, LReLU, and MPELU.

$$ReLU ( x ) = \{ \begin{matrix}x , & if x \geq 0 \\ 0 , & if x < 0\end{matrix} \qquad ( 4 )$$

All the above activation functions compute the activation value one by one. If an element x is to be activated by an activation function, the information of neighbours of x is not taken into account. In addition, the existing activation function is one-dimensional activation function. However the one-dimensional activation function can not provide higher accuracy of the deep learning algorithm.

To overcome or mitigate the above-mentioned problem or other problems of one-dimensional activation function, the embodiments of the disclosure propose two-dimensional activation function for deep learning, which can be used in any suitable deep learning algorithm/architecture.

The two-dimensional activation function ƒ(x,y) may comprise a first parameter x representing an element to be activated and a second parameter y representing the element's neighbors.

In an embodiment, the second parameter y may be expressed by at least one of the number of the element's neighbors and the difference between the element and its neighbors. For example, the second parameter may be expressed by

$$y = \frac{{\sum }_{z ∈ Ω ( x )} {( x - z )}^{2}}{N ( Ω ( x ) )} \qquad ( 5 )$$

where Ω(x) is a set of the element x's neighbors, z is an element of Ω(x) and N(Ω(x)) is the number of elements of Ω(x). In other embodiments, the second parameter may be expressed in any other suitable form.

In an embodiment, the two-dimensional activation function ƒ(x,y) is defined as

$$f ( x , y ) = \frac{1}{1 + {e}^{- x}} \times \frac{1 + {e}^{- 2 y}}{1 + {e}^{- 2 y}} \qquad ( 6 )$$

In other embodiment, the two-dimensional activation function may be expressed in the manner of any other suitable two-dimensional function.

The above two-dimensional activation function ƒ(x,y) can be used in any architecture of deep learning algorithm. What should be done is replacing the traditional activation function with the above two-dimensional activation function and then training the network with standard back-propagation algorithm.

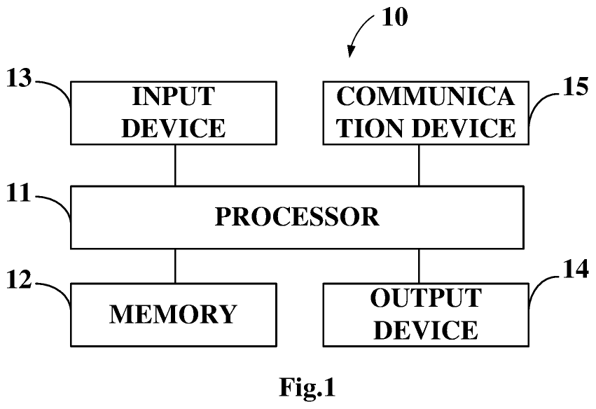

FIG. 1 is a simplified block diagram showing an apparatus, such as an electronic apparatus 10, in which various embodiments of the disclosure may be applied. It should be understood, however, that the electronic apparatus as illustrated and hereinafter described is merely illustrative of an apparatus that could benefit from embodiments of the disclosure and, therefore, should not be taken to limit the scope of the disclosure. While the electronic apparatus 10 is illustrated and will be hereinafter described for purposes of example, other types of apparatuses may readily employ embodiments of the disclosure. The electronic apparatus 10 may be a portable digital assistant (PDAs), a user equipment, a mobile computer, a desktop computer, a smart television, an intelligent glass, a gaming apparatus, a laptop computer, a media player, a camera, a video recorder, a mobile phone, a global positioning system (GPS) apparatus, a smart phone, a tablet, a server, a thin client, a cloud computer, a virtual server, a set-top box, a computing device, a distributed system, a smart glass, a vehicle navigation system, an advanced driver assistance systems (ADAS), a self-driving apparatus, a video surveillance apparatus, an intelligent robotics, a virtual reality apparatus and/or any other types of electronic systems. The electronic apparatus 10 may run with any kind of operating system including, but not limited to, Windows, Linux, UNIX, Android, iOS and their variants. Moreover, the apparatus of at least one example embodiment need not to be the entire electronic apparatus, but may be a component or group of components of the electronic apparatus in other example embodiments.

Furthermore, the electronic apparatus may readily employ embodiments of the disclosure regardless of their intent to provide mobility. In this regard, it should be understood that embodiments of the disclosure may be utilized in conjunction with a variety of applications.

In at least one example embodiment, the electronic apparatus 10 may comprise processor 11 and memory 12. Processor 11 may be any type of processor, controller, embedded controller, processor core, graphics processing unit (GPU) and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), and/or the like.

Processor 11 may comprise means, such as circuitry, for implementing audio, video, communication, navigation, logic functions, and/or the like, as well as for implementing embodiments of the disclosure including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 11 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output Device 14 may comprise a visual output device, such as a display, a light, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, a removable storage device and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format, a moving picture expert group (MPEG) standard format, a Video Coding Experts Group (VCEG) standard format or any other suitable standard formats.

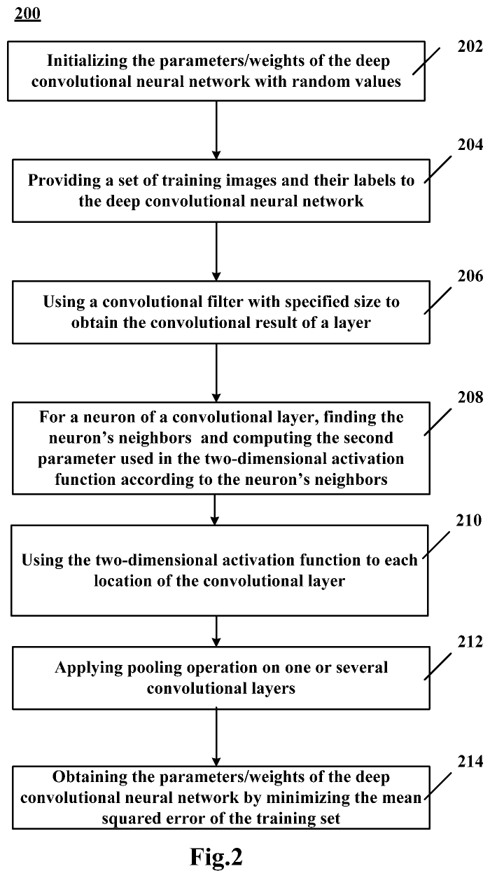

FIG. 2 is a flow chart depicting a process 200 of a training stage of deep learning according to embodiments of the present disclosure, which may be performed at an apparatus such as the electronic apparatus 10 (for example a distributed system or cloud computing) of FIG. 1. As such, the electronic apparatus 10 may provide means for accomplishing various parts of the process 200 as well as means for accomplishing other processes in conjunction with other components.

The deep learning may be implemented in any suitable deep learning architecture/algorithm which uses at least one activation function. For example, the deep learning architecture/algorithm may be based on neural networks, convolutional neural networks, etc. and their variants. In this embodiment, the deep learning is implemented by using a deep convolutional neural network, and used to image recognition. In addition, as mentioned above, the traditional activation function used in the deep convolutional neural network is required to be replaced with the two-dimensional activation function.

As shown in FIG. 2, the process 200 may start at block 202 where the parameters/weights of the deep convolutional neural network are initialized with for example random values. Parameters like the number of filters, filter sizes, architecture of the network etc. have all been fixed before block 202 and do not change during the training stage. In addition, the traditional activation function used in the deep convolutional neural network is replaced with the two-dimensional activation function of embodiments of the disclosure.

At block 204, providing a set of training images and their labels to the deep convolutional neural network. For example, a label may indicate that an image is either an object or background. The set of training images and their labels may be pre-stored in a memory of the electronic apparatus 10, or retrieved from a network location or a local location. The deep convolutional neural network may comprise one or more convolutional layers. There may be a number of feature maps in a layer. For example, the number of feature maps in layer i is Nᵢ and the number of feature maps in layer i−1 is Nᵢ₋₁.

At block 206, using a convolutional filter Wᵢ with specified size to obtain the convolutional result of layer i.

At block 208, for the convolutional result (a neuron) x of a convolutional layer i, finding the neuron's neighbors Ω(x) and computing the second parameter y used in the two-dimensional activation function according to Ω(x). In this embodiment, y may be computed according to above equation 5. The neuron's neighbors may be predefined.

At block 210, using the two-dimensional activation function to each location of the convolutional layer, for example computing the activation result of x by using the two-dimensional activation function ƒ(x,y). In this embodiment, ƒ(x,y) may be expressed by above equation 6. The activation result of a convolutional layer is also called a convolutional layer.

At block 212, applying pooling operation on one or several convolutional layers (if required).

At block 214, obtaining the parameters/weights (such as the filter parameters and connection weights, etc.) of the deep convolutional neural network by minimizing the mean squared error of the training set. The standard back-propagation algorithm can be used for solving the minimization problem. In the back-propagation algorithm, the gradients of the mean squared error with respect to the parameters of the filters are computed and back-propagated. The back-propagation is conducted in several epochs until convergence.

With architecture and the parameters obtained in the training stage, the trained deep convolutional neural network can be used for classifying an image or a patch of an image.

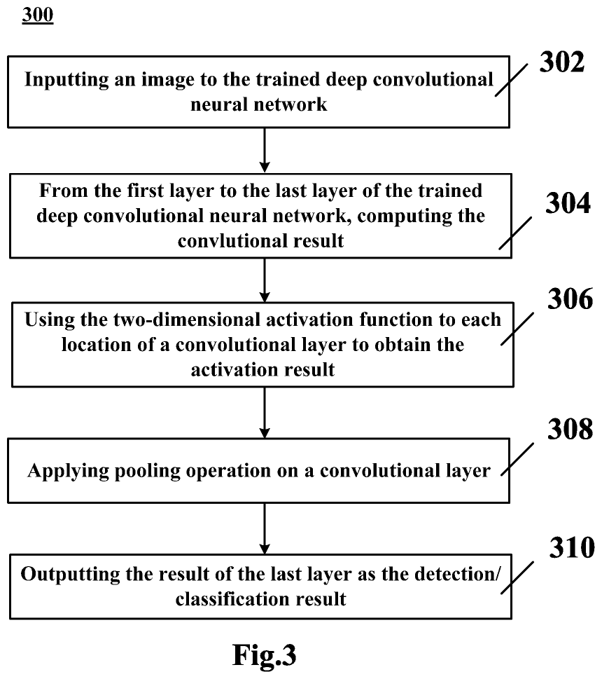

FIG. 3 is a flow chart depicting a process 300 of a testing stage of deep learning according to embodiments of the present disclosure, which may be performed at an apparatus such as the electronic apparatus 10 (for example an advanced driver assistance system (ADAS) or a self-driving apparatus) of FIG. 1. As such, the electronic apparatus 10 may provide means for accomplishing various parts of the process 300 as well as means for accomplishing other processes in conjunction with other components.

In this embodiment, the deep learning is implemented by using a deep convolutional neural network, and used to image recognition. In addition, as mentioned above, the traditional activation function used in the deep convolutional neural network is required to be replaced with the two-dimensional activation function. Moreover, the deep convolutional neural network has been trained by using the process 200 of FIG. 2.

As shown in FIG. 3, the process 300 may start at block 302 where an image is input to the trained deep convolutional neural network. For example, the image may be captured by the ADAS/autonomous vehicle.

At block 304, from the first layer to the last layer of the trained deep convolutional neural network, computing the convolutional result.

At block 306, using the two-dimensional activation function to each location of a convolutional layer to obtain the activation result.

At block 308, applying pooling operation (such as max-pooling) on a convolutional layer (if required).

At block 310, outputting the result of the last layer as the detection/classification result.

In an embodiment, the deep learning architecture with the two-dimensional activation function is used in the ADAS/autonomous vehicle, such as for object detection. For example, a vision system is equipped with the ADAS or autonomous vehicle. The deep learning architecture with the two-dimensional activation function can be integrated into the vision system. In the vision system, an image is captured by a camera and the important objects such as pedestrians and bicycles are detected from the image by a trained deep CNN where the proposed two-dimensional activation function is employed. In the ADAS, some forms (e.g., warning voice) of warning may be generated if important objects (e.g., pedestrians) are detected so that the driver in the vehicle can pay attention to the objects and try to avoid traffic accident. In the Autonomous Vehicle, the detected objects may be used as inputs of a control module and the control module takes proper action according to the objects.

Traditional activation function is one-dimensional whereas the activation function of the embodiments is two-dimensional. Because the two-dimensional function can fully and jointly model two variables, the method of the embodiments is more powerful for feature representation of deep learning. Consequently, the deep learning adopting the proposed two-dimensional activation function can yields better recognition rate.

Table 1 shows some results of method of the embodiments on the CIFAR10 dataset and the ImageNet dataset. Comparison is done with the classical NIN method and the VGG method, wherein the classical NIN method is described by Nair V, Hinton G E. “Rectified linear units improve restricted boltzmann machines”, in Proceedings of the 27th International Conference on Machine Learning, Haifa, 2010:807-814, and the VGG method is described by Xavier Glorot, Antoine Bordes and Yoshua Bengio, “Deep Sparse Rectifier Neural Networks”, in Proceedings of the Fourteenth International Conference on Artificial Intelligence and Statistics (AISTATS-11), 2011, Pages: 315-323, the disclosures of which are incorporated by reference herein in their entirety.

The method of the embodiments adopts the same architecture as that of NIN and that of VGG. In the NIN method and VGG method, the classical ReLU activation function is employed. But in the method of the embodiments of the disclosure, the ReLU activation function is replaced with the two-dimensional activation function such as above equation 6. Table 1 gives the recognition error rates of different methods on different datasets. From Table 1, one can see that replacing the ReLU activation function with the proposed two-dimensional activation function significantly improves the recognition performance.

TABLE 1
Recognition error rate

| | | NIN with | | VGG with the |
|---|---|---|---|---|
| | | the proposed | | proposed |
| | NIN with | two- | VGG with the | two- |
| | the ReLU | dimensional | ReLU | dimensional |
| | activation | activation | activation | activation |
| | function | function | function | function |
| CIFAR10 | 10.41% | 9.38% | 7.91% | 6.84 |
| dataset | | | | |
| ImageNet | N/A | N/A | 23.7% | 21.4% |
| dataset | | | | |

According to an aspect of the disclosure it is provided an apparatus for deep learning. For same parts as in the previous embodiments, the description thereof may be omitted as appropriate. The apparatus may comprise means configured to carry out the processes described above. In an embodiment, the apparatus comprises means configured to use a two-dimensional activation function in a deep learning architecture, wherein the two-dimensional activation function comprises a first parameter representing an element to be activated and a second parameter representing the element's neighbors.

In an embodiment, the second parameter is expressed by at least one of the number of the element's neighbors and the difference between the element and its neighbors.

In an embodiment, wherein the second parameter is expressed by

$$y = \frac{{\sum }_{z ∈ Ω ( x )} {( x - z )}^{2}}{N ( Ω ( x ) )} ,$$

where Ω(x) is a set of the element x's neighbors, z is an element of Ω(x) and N(Ω(x)) is the number of elements of Ω(x).

In an embodiment, wherein the two-dimensional activation function ƒ(x,y) is defined as

$$f ( x , y ) = \frac{1}{1 + {e}^{- x}} \times \frac{1 + {e}^{- 2 y}}{1 + {e}^{- 2 y}} ,$$

where x is the first parameter and y is the second parameter.

In an embodiment, wherein the deep learning architecture is based on a neural network.

In an embodiment, the neural network comprises a convolutional neural network.

In an embodiment, the apparatus may further comprise means configured to use the two-dimensional activation function in a training stage of the deep learning architecture.

In an embodiment, the deep learning architecture is used in an advanced driver assistance system/autonomous vehicle.

It is noted that any of the components of the apparatus described above can be implemented as hardware or software modules. In the case of software modules, they can be embodied on a tangible computer-readable recordable storage medium. All of the software modules (or any subset thereof) can be on the same medium, or each can be on a different medium, for example. The software modules can run, for example, on a hardware processor. The method steps can then be carried out using the distinct software modules, as described above, executing on a hardware processor.

Additionally, an aspect of the disclosure can make use of software running on a general purpose computer or workstation. Such an implementation might employ, for example, a processor, a memory, and an input/output interface formed, for example, by a display and a keyboard. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. The processor, memory, and input/output interface such as display and keyboard can be interconnected, for example, via bus as part of a data processing unit. Suitable interconnections, for example via bus, can also be provided to a network interface, such as a network card, which can be provided to interface with a computer network, and to a media interface, such as a diskette or CD-ROM drive, which can be provided to interface with media.

Accordingly, computer software including instructions or code for performing the methodologies of the disclosure, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

As noted, aspects of the disclosure may take the form of a computer program product embodied in a computer readable medium having computer readable program code embodied thereon. Also, any combination of computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the disclosure may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

The flowchart and block diagrams in the figures illustrate the architecture, functionality, and operation of possible implementations of apparatus, methods and computer program products according to various embodiments of the disclosure. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein, two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical region (both visible and invisible), as several non-limiting and non-exhaustive examples.

In any case, it should be understood that the components illustrated in this disclosure may be implemented in various forms of hardware, software, or combinations thereof, for example, application specific integrated circuit(s) (ASICS), a functional circuitry, a graphics processing unit, an appropriately programmed general purpose digital computer with associated memory, and the like. Given the teachings of the disclosure provided herein, one of ordinary skill in the related art will be able to contemplate other implementations of the components of the disclosure.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

1. An apparatus, comprising:
at least one processor;
at least one memory including computer program code, the memory and the computer program code configured to, working with the at least one processor, cause the apparatus to
use a two-dimensional activation function in a deep learning architecture,
wherein the two-dimensional activation function comprises a first parameter representing an element to be activated and a second parameter representing the element's neighbors.

2. The apparatus according to claim 1, wherein the second parameter is expressed by at least one of a number of the element's neighbors and a difference between the element and its neighbors.

3. The apparatus according to claim 2, wherein the second parameter is expressed by
$$y = \frac{{\sum }_{z ∈ Ω ( x )} {( x - z )}^{2}}{N ( Ω ( x ) )} ,$$
where Ω(x) is a set of the element x's neighbors, z is an element of Ω(x) and N(Ω(x)) is the number of elements of Ω(x).

4. The apparatus according to claim 1, wherein the two-dimensional activation function ƒ(x,y) is defined as
$$f ( x , y ) = \frac{1}{1 + {e}^{- x}} \times \frac{1 + {e}^{- 2 y}}{1 + {e}^{- 2 y}} ,$$
where x is the first parameter and y is the second parameter.

5. The apparatus according to claim 1, wherein the deep learning architecture is based on a neural network.

6. The apparatus according to claim 5, wherein the neural network comprises a convolutional neural network.

7. The apparatus according to claim 1, wherein the memory and the computer program code is further configured to, working with the at least one processor, cause the apparatus to
use the two-dimensional activation function in a training stage of the deep learning architecture.

8. The apparatus according to claim 1, wherein the deep learning architecture is used in an advanced driver assistance system/autonomous vehicle.

9. A method comprising:
using a two-dimensional activation function in a deep learning architecture,
wherein the two-dimensional activation function comprises a first parameter representing an element to be activated and a second parameter representing the element's neighbors.

10. The method according to claim 9, wherein the second parameter is expressed by at least one of a number of the element's neighbors and a difference between the element and its neighbors.

11. The method according to claim 10, wherein the second parameter is expressed by
$$y = \frac{{\sum }_{z ∈ Ω ( x )} {( x - z )}^{2}}{N ( Ω ( x ) )} ,$$
where Ω(x) is a set of the element x's neighbors, z is an element of Ω(x) and N(Ω(x)) is the number of elements of Ω(x).

12. The method according to claim 9, wherein the two-dimensional activation function ƒ(x,y) is defined as
$$f ( x , y ) = \frac{1}{1 + {e}^{- x}} \times \frac{1 + {e}^{- 2 y}}{1 + {e}^{- 2 y}} ,$$
where x is the first parameter and y is the second parameter.

13. The method according to claim 9, wherein the deep learning architecture is based on a neural network.

14. The method according to claim 13, wherein the neural network comprises a convolutional neural network.

15. The method according to claim 9, further comprising
using the two-dimensional activation function in a training stage of the deep learning architecture.

16. The method according to claim 9, wherein the deep learning architecture is used in an advanced driver assistance system/autonomous vehicle.

17. (canceled)

18. (canceled)

19. A non-transitory computer readable medium having encoded thereon statements and instructions to cause a processor to execute a method, comprising
using a two-dimensional activation function in a deep learning architecture,
wherein the two-dimensional activation function comprises a first parameter representing an element to be activated and a second parameter representing the element's neighbors.
